(19) United States
(12) Patent Application Publication
(10) Pub. No.: US 2003/0065736 A1
(43) Pub. Date: Apr. 3, 2003

(54) System, method, and apparatus for preventing data packet overflow at plurality of nodes in wireless packet data services network

(76) Inventors: Jogen K. Pathak, Irving, TX (US); Vyankatesh Shanbhag, Plano, TX (US)

Correspondence Address: R. Scott Rhoades, Strasburger & Price, L.L.P., Suite 4300, 901 Main Street, Dallas, TX, 75202-3794, US

(21) Appl. No.: 10/289,873

(22) Filed: Nov. 7, 2002

Related U.S. Application Data
(63) Continuation-in-part of application No. 09/915,010, filed on Jul. 25, 2001.
(60) Provisional application No. 60/347,813, filed on Nov. 7, 2001.
(60) Provisional application No. 60/374,594, filed on Apr. 22, 2002.

(51) Int. Cl. G06F 15/167; G06F 15/16

(52) U.S. Cl. 709/212; 709/203

(57) ABSTRACT

A technique as well as associated systems, methods, and apparatuses for preventing an overflow of data packets at a plurality of nodes in a wireless data network is presented herein. The amount of available allocated memory at the plurality of nodes for a wireless client is monitored by a wireless content switch. The wireless content switch also intercepts a signal transmitted from the wireless client which indicates the amount of available memory at the wireless client. The wireless content switch modifies the signal such that the indicated amount of memory does not exceed the amount of memory allocated at the plurality of nodes for the wireless client.

### CROSS-REFERENCE TO RELATED APPLICATIONS

This application claims the priority benefit of U.S. Provisional Application for Patent, Serial No. 60/347,813, entitled “System, Method, And Apparatus For Preventing Data Packet Overflow At Plurality Of Nodes In Wireless Packet Data Services Network,” filed on Nov. 7, 2001 and claims the priority benefit of U.S. Provisional Application for Patent, Serial No. 60/374,594, entitled “System, Method, And Apparatus For Preventing Data Packet Overflow At Plurality Of Nodes In Wireless Packet Data Services Network,” filed on Apr. 22, 2002, and is a continuation in part of copending application for U.S. patent Ser. No. 09/915,010, “System, Method, and Apparatus for Preventing Data Packet Overflow at Node in Wireless Network”, by Pathak, et. al., filed Jul. 25, 2001, all of which are hereby incorporated by reference for all purposes.

### STATEMENT REGARDING FEDERALLY SPONSORED RESEARCH/DEVELOPMENT

Not Applicable.

1. Field

The present application relates to wireless packet data services networks, and more particularly to a technique as well as associated systems, methods, and apparatuses for preventing data packet overflow in a wireless packet data services network.

2. Background

The available bandwidth for transmission of the data packets over the wireless air interface is usually lower relative to other parts of a communication network. As a result, data packets can be received by a communication network at a faster rate than data packets are transmitted wirelessly, resulting in a backlog of data packets awaiting transmission over the air interface. Such backlog is partly accommodated by storing the backlog of data packets at different nodes, and partly prevented by congestion avoidance mechanisms.

When the memory allocated to a wireless client at the nodes is consumed by the backlog of data packets, additional data packets which are received are discarded. Such a condition is made known to the sender of the data packets using a scheme of acknowledgment messages. The acknowledgment messages acknowledge receipt of certain identified data packets. When the sender fails to receive an acknowledgment for sent data packets within a certain delay period, the sender retransmits the data packets.

Pursuant to the Transmission Control Protocol (TCP), the sender also invokes congestion avoidance mechanisms. Congestion avoidance mechanisms cause a sender to significantly drop the transmission rate to some predetermined minimum transmission rate. The transmission rate is then progressively increased as the recipient acknowledges receipt of the data packets. Progressively increasing the transmission rate is known as “ramping up”.

The wireless client informs the sender of its memory capability in the acknowledgements it sends to the sender. However, the sender is not made aware of the limits of the available memory allocated to the wireless client at the node in the wireless network. Accordingly, the ramping can continue to progressively increase the transmission rate to a rate which exhausts the memory at the nodes. Exhausting the memory at the nodes causes subsequent packets to be discarded. When the packets are discarded, the congestion avoidance mechanism is again invoked.

Controlling the transmission rate of the sender in the foregoing manner is disadvantageous because bandwidth is wasted during the time that the nodes discards the data packets. Additionally, at the beginning of the ramping up time, the minimum transmission rate underutilizes the available bandwidth, which also results in wasted bandwidth.

Accordingly, it would be desirable if data packet overflow at the wireless network nodes is prevented.

### SUMMARY

A system, method, and apparatus are presented herein for preventing data overflow of wireless network nodes. The data transmission rate at a content server is dynamically limited to prevent transmission at a rate which would cause the memory at network nodes allocated for the wireless client to be exhausted. A signal transmitted from the wireless client indicating the amount of available memory at the wireless client is intercepted by a wireless content switch which monitors the nodes and estimates the available memory at the nodes which is allocated to the wireless client. The wireless content switch modifies the signal transmitted from the wireless client in a manner such that the total available memory indicated does not exceed the cumulative available memory allocated at the nodes.

### BRIEF DESCRIPTION OF THE DRAWINGS

FIG. 1 is a diagram of a wireless data services network;

FIG. 2 is a diagram describing the operation of an exemplary wireless content switch;

FIG. 3 is a diagram of wireless data services network in accordance with General Packet Radio Services specifications;

FIG. 4 is a block diagram of an exemplary wireless content switch; and

FIG. 5 is a signal flow diagram describing the operation of the wireless content switch in the GPRS network.

### DETAILED DESCRIPTION OF THE DRAWINGS

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

Referring now to FIG. 1, there is illustrated a diagram of a communication network, referenced generally by the numeric designation 100, for transmitting data packets to a wireless client 105 from a content server 110. The wireless client 105 is a mobile terminal generally associated with a user or subscriber to the communication network 100, and can comprise, but is not limited to, a mobile station, a personal digital assistant, or a lap top or palm top computer capable of engaging in wireless data communications.

The content server 110 is a server computer that can include, for example, a web server. The content server 110 is generally connected to a wired network 115. The wired network 115 can comprise, for example, a local area network, a wide area network, or the internet. Data is transmitted over the wired network 115 in a series of sequential partitions, known as data packets.

The wired network 115 is interfaced with a wireless network 120 associated with the wireless client 105. The wireless network 120 includes a network of nodes which are often overlay a cellular telephone network, such as the Global System for Mobile Telecommunications (GSM). The network of nodes routes the data packets to a geographic location within radio communication of the wireless client 105 and transmits the data packets over the wireless air interface to the wireless client 105. The wireless network 120 also includes a wireless content switch 125. The wireless content switch 125 is positioned in a manner to receive communications transmitted to and from nodes of the wireless network 120 for the wireless client 105.

The amount of data that the wireless client 105 can receive is limited by the available memory at the wireless client 105. The data received by the wireless client 105 is temporarily stored for use by the wireless client 105. Storage of the data in temporary memory reduces the amount of available memory. Data received when memory is completely consumed is discarded. Therefore, it is important to dynamically limit the data rate delivered to the wireless client 105 to prevent exhausting the memory at the wireless client 105. The data rate is limited by transmitting a signal which indicates the available memory at the wireless client 105.

The amount of data that the wireless client 105 can receive is also limited by conditions in the wireless network 120. Available bandwidth for transmission of data packets over the wireless air interface is usually lower relative to other parts of the communication network 100. As a result, the data packets can be received by the wireless network 120 at a faster rate than the data packets are transmitted, resulting in a backlog of data packets awaiting transmission over the air interface. The foregoing backlog is partly accommodated by storing the backlog of data packets at different nodes in the network.

The wireless network 120 allocates a certain amount of memory at different nodes to each of any number of wireless clients 105 receiving service from the wireless network 120. The memory allocated to the wireless client 105 stores the backlog of data packets for the wireless client 105 which await transmission over the wireless air interface. The amount of backlog which can be accommodated for a wireless client 105 is thereby limited by the amount of memory allocated to the wireless client 105 in the nodes. When the memory allocated to the wireless client 105 is consumed by the backlog of data packets, additional data packets received from the content server 110 are discarded.

The discarding of data packets is prevented by dynamically limiting the amount of data transmitted by the content server 110. The wireless content switch 125 monitors the available memory at the different nodes in the wireless network 120 which is allocated for the wireless client 105. When the wireless client 105 transmits the signal indicating the amount of memory available at the wireless client 105, the signal is also received by the wireless content switch 125. The wireless content switch 125 compares the amount of memory available at the wireless client 105 with the combined amount of allocated memory available at the nodes. Where the combined amount of allocated memory available at the node is less than the amount of memory available at the wireless client 105, the wireless content switch 125 replaces the signal value indicating the amount of memory available at the wireless client 105 with the combined amount of allocated memory available at the nodes.

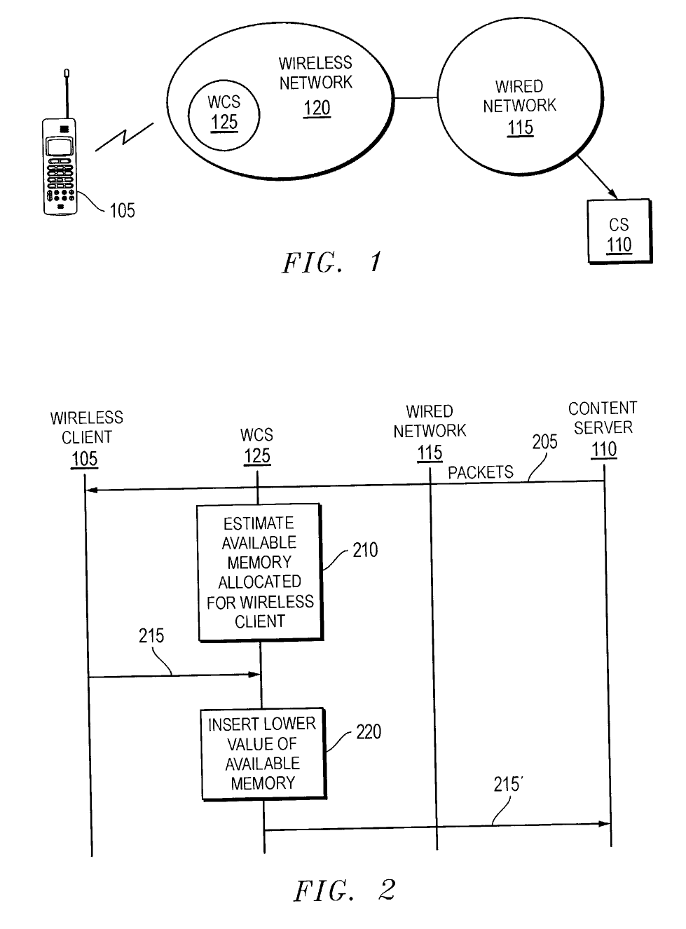

Referring now to FIG. 2, there is illustrated a diagram describing the operation of an exemplary wireless content switch. As the content server 110 transmits data packets (signal 205) to the wireless client 105, the data packets are received by the wireless content switch 125. Based on the amount of data in the packets, the wireless content switch 125 estimates (action 210) the available memory allocated for the wireless client 105. As the wireless client 105 receives the data packets, the wireless client 105 transmits signals towards the content server 110 which indicate the amount of memory available at the wireless client (signal 215). The signals are received at the wireless content switch 125. The wireless content switch 125 compares the estimated available memory allocated for the wireless client at the node with the available memory at the wireless client 105 which is indicated in signal 215. The lower of the two values is inserted into the signal 215 (action 220), and the signal 215′ is transmitted to the content server 110

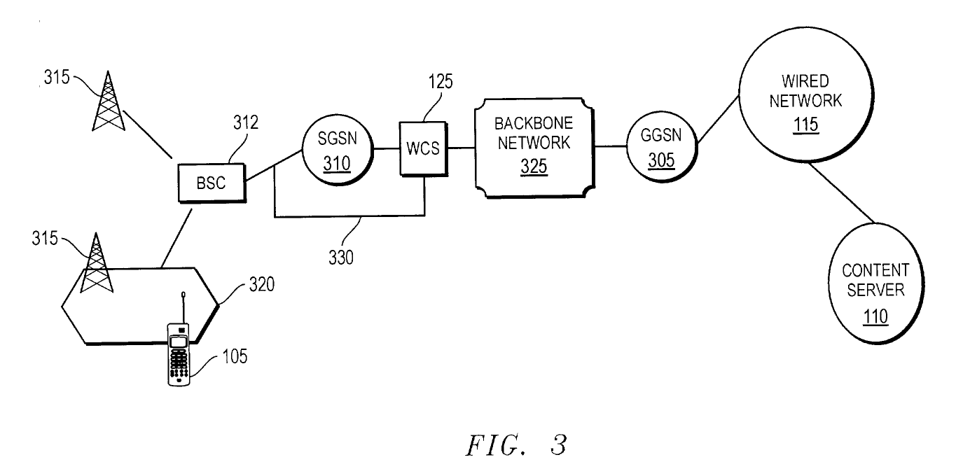

Referring now to FIG. 3, there is illustrated a diagram of a wireless services network in accordance with the specifications of the General Packet Radio Services (GPRS) standard. It is noted that certain elements have been omitted for the purposes of simplicity, and therefore, the figure is not intended as an exhaustive illustration. Pursuant to GSM and GPRS specifications, the wireless network 120 is interfaced with the wired network 115 by any number of Gateway GPRS Support Nodes (GGSN) 305. Each GGSN 305 is associated with any number of IP addresses which the GGSN 305, in turn, allocates to wireless clients 105.

The wireless network 120 provides packet data services to geographical areas which are divided into routing areas. Each routing area is associated with a particular Service GPRS Support Node (SGSN) 310. Each SGSN 310 is associated with any number of base station controllers 312. Each base station controller 312 is associated with and controls one or more base transceiver stations 315. The base transceiver station 315 is the radio transceiver equipment which transmits and receives signals to and from the wireless client 105. Base transceiver stations 315 maintain radio frequency communications with a geographic area known as a cell 320.

The SGSNs 310 and the GGSNs 305 are interconnected by a backbone network 325. The backbone network 325 routes packet data between the SGSNs 310 and the GGSNs 305. During transmission from the content server 110 to the wireless client 105, the content server 110 transmits the data packets to an IP address associated with the GGSN 305. The GGSN 305 receives the data packet, determines the identity and location of the wireless client 105 associated with the IP address, and forwards the packet towards the wireless client 105.

The amount of data that the wireless client 105 can receive is limited by the available memory at the wireless client 105. The data rate is limited to prevent exhausting the memory at the wireless client 105 by transmission of a signal which indicates the available memory at the wireless client 105.

The amount of data that the wireless client 105 can receive is also limited by conditions in the wireless network 120. The data packets can be received by the wireless network 120 at a faster rate than the data packets are transmitted, resulting in a backlog of data packets awaiting transmission over the air interface. The foregoing backlog is accommodated by storing the backlog of data packets at the SGSN 310 and at the base station controller 312. The SGSN 310 and base station controller 312 allocate certain amounts of memory to each of any number of wireless clients 105 receiving service from the wireless communication network 120. The memory allocated to the wireless client 105 stores the backlog of data packets for the wireless client 105 which await transmission over the wireless air interface. When the memory allocated to the wireless client 105 is consumed by the backlog of data packets, additional data packets which are received from the content server 110 are discarded.

The foregoing is prevented by dynamically limiting the amount of data transmitted by the content server 110. The wireless content switch 125 is connected in a manner surrounding the SGSN 310. For example, in one embodiment, the wireless content switch 125 can be connected directly to the SGSN 310, between the SGSN 310 and the backbone network 325, and have a second connection directly in front of the SGSN 310 between the SGSN 310 and the base station controller 312. The interface between the SGSN 310 and the backbone network 325 is known as the Gn interface. The interface between the SGSN 310 and the BSC 312 is known as the Gb interface.

The wireless content switch 125 is connected between the SGSN 310 and the backbone network 325. Additionally, the Wireless Content Switch 125 is also connected between the BSC 312 and the SGSN 310, via connection 330. Therefore, the wireless content switch 125 receives all of the data transmitted to the SGSN 310 and all of the data transmitted from the SGSN 310. Accordingly, the wireless content switch 125 can monitor the amount of incoming data and outgoing data for wireless client 105 at the SGSN 310. In one exemplary embodiment, the wireless content switch 125 is an Intelligent Packet Control Node (IPCN) developed and manufactured by Cyneta Networks, Inc.

The wireless content switch 125 estimates the available memory at the SGSN 310. The available memory allocated to the wireless client at the SGSN 310 is estimated by determining the amount of memory allocated to the wireless client 105 and estimating the amount of data stored in the memory allocated to the wireless client 105. The amount of data stored in the memory allocated to the wireless client 105 is estimated by monitoring the incoming data and outgoing data for the wireless client 105 at the SGSN 310 and determining the difference.

Additionally, the wireless content switch 125 estimates the available memory at the base station controller 312. The available memory allocated to the wireless client 105 at the base station controller 312 is estimated by determining the amount of memory allocated to the wireless client 105 and estimating the amount of data stored in the memory allocated to the wireless client 105. The amount of data stored in the memory allocated to the wireless client 105 is estimated by monitoring the incoming data at the base station controller 312 and the throughput rate for the wireless client 105, and determining the difference.

When the wireless client 105 transmits the signal indicating the amount of memory available at the wireless client 105, the signal is received by the wireless content switch 125. The wireless content switch 125 compares the amount of memory available at the wireless client 105 with the combined amount of allocated memory available at SGSN 310 and at the BSC 312. Where the combined amount of allocated memory available at the SGSN 310 and the BSC 312 is less than the amount of memory available at the wireless client 105, the wireless content switch 125 replaces the signal value indicating the combined amount of memory available at the wireless client 105 with a value indicating the amount of allocated memory available at the SGSN 310 and the BSC 312.

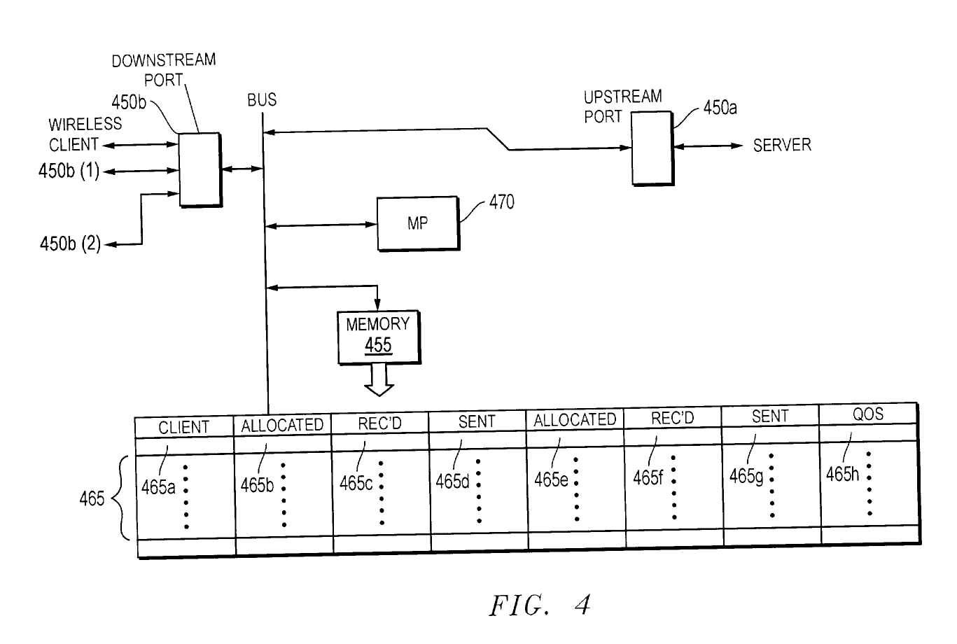

Referring now to FIG. 4, there is illustrated a block diagram of an exemplary wireless content switch 125. The wireless content switch 125 includes any number of upstream ports 450 and downstream ports 450b. The upstream ports 450a facilitate connection of the wireless content switch 115 towards the content server 110 via a trunk line, such as, for example, a T1, E1, or an Ethernet connection, to name a few. In one embodiment, an upstream port 450a can be connected to the backbone network 325 via a trunk line. Similarly, the downstream ports 450b facilitate connection of the wireless content switch 125 towards the wireless client 105 via a trunk line. Connection of the ports permits receipt and transmission of data packets, acknowledgments, Quality of Service (QOS), and other signals between the wireless client 105 and the content server 110.

The downstream ports 450b include server side port 450b(1), which is connected to the SGSN 310 on the server side and a client side port 450b(2), which is connected to the SGSN 310 on the client side. Connection of the ports 450b(1), 450b(2) permits monitoring the amount of data received at the SGSN 310 and the data sent by the SGSN 310, and the data received by the base station controller 312. The downstream ports 450b also permit the wireless content switch 125 to receive signals, such as signals which indicate the amount of memory available at the wireless client 105, the throughput rate at the wireless client 105 and transmit the data packets to the SGSN 310.

The wireless content switch 125 also includes memory 455 for storing a memory allocation table 460. The memory allocation table 460 includes any number of records 465, each of which are associated with a particular wireless client 105 receiving wireless packet data services from the SGSN 310. Each record contains a client identifier 465a, an SGSN allocated memory indicator 465b, an SGSN received data indicator 465c, and an SGSN sent data indicator 465d, a BSC allocated memory indicator 465e, a BSC received data indicator 465f, a BSC sent indicator 465g, and a throughput rate indicator 465h. The client identifier 465a identifies the wireless client 105 associated with the record 465. The SGSN allocated memory indicator 465b stores the amount of memory allocated for the wireless client 105 at the SGSN 310. The SGSN received data indicator 465c stores the amount of data received for the wireless client 105 associated with the record 465 at the SGSN 310. The SGSN sent data indicator 465d stores the amount of data that has been sent for the wireless client 105 associated with record 465a from the SGSN 310. The BSC allocated memory indicator 465e stores the amount of memory allocated for the wireless client 105 at the BSC 312. The BSC received data indicator 465f stores the amount of data received for the wireless client 105 associated with the record 465 at the BSC 312. The BSC sent indicator 465g indicates the amount of data that the wireless client 105 has received. The throughput rate indicator 465h indicates the throughput rate at which data is received at the wireless client 105.

The memory 455 can also store a plurality of instructions executable by a processor 470. The foregoing instructions when executed by processor 470 to create and initialized each record 465 when a wireless client 105 commences data services from the SGSN 310. When a data packet for a wireless client 105 is transmitted by the server side port 450b(1) to the SGSN 310, the identity of the wireless client 105 is determined by the processor 470. Upon determination of the identity of the wireless client 105, the SGSN received data indicator 465c is incremented by the processor 470 by the amount of data in the data packet. When a data packet is received at client side port 450b(2) for a wireless client 105, the identity of the wireless client 105 is determined, and the SGSN sent data indicator 465d and the BSC received data indicator are incremented by the processor 470 by the amount of data in the data packet. In the foregoing manner, the amount of data that is sent and received for each wireless client 105 via SGSN 310 is tracked, as well as the amount of data received at the BSC 312. When a Quality of Service Parameter is received from the wireless client 105, the processor 470 examines the parameter to determine the throughput rate at which the data is being received at the wireless client 105. Based on the throughput rate, the processor 470 determines the amount of data that has been received at the wireless client 105, and correspondingly, the amount of data transmitted from the base station controller 312. The BSC sent indicator 465g of the record associated with the wireless client 105 is then incremented.

The memory 455, processor 470, upstream ports 450a, and downstream ports 450b are interconnected by a bus 475 that facilitates the transmission of signals therebetween.

The wireless content switch 125 is discussed further in U.S. patent application Ser. No. 09/839,830 entitled “System and Method for Wireless Packet Data Content Switch,” which is commonly owned and assigned with the present application and in U.S. patent application Ser. No. 09/884,663 entitled “Packet Retransmission in Wireless Packet Data Networks,” which is commonly owned and assigned with the present application and both of which are hereby incorporated by reference.

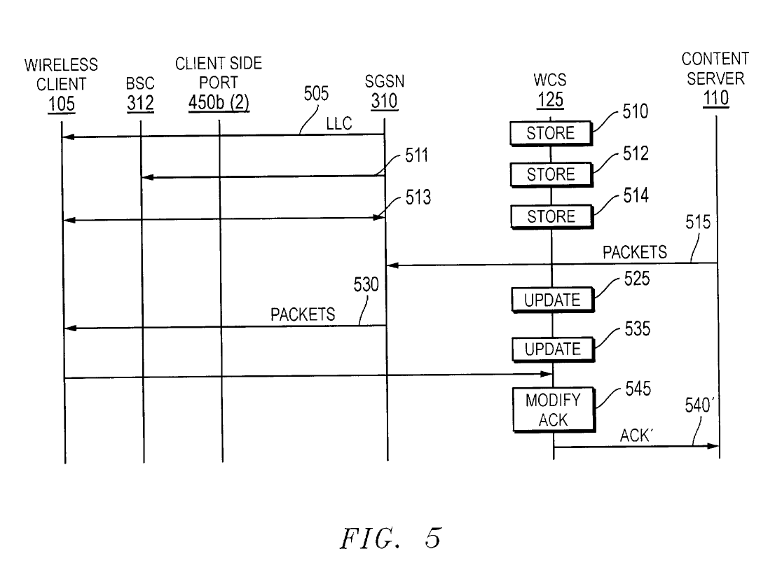

Referring now to FIG. 5, there is illustrated a signal flow diagram describing the operation of the network described in FIG. 3. When wireless client 105 initiates an internet session with SGSN 310, the SGSN 310 transmits a Link Layer Control signal (signal 505) to the wireless client 105. The Link Layer Control signal 405 includes a field which indicates the amount of buffer memory allocated at the SGSN 310 for the wireless client 105. The foregoing link layer control signal 405 is also received at the client side port 450a(2). Upon receipt of the link layer control signal 405, the field indicating the amount of buffer memory allocated to the SGSN 310 is stored at the memory allocated indicator 465b in the record 465 associated with the wireless client 105 (action 510) by wireless content switch 125.

Additionally, a packet flow control message (signal 511) is transmitted by the SGSN 310 to the BSC 312. The packet flow control message is received at the wireless content switch, client side port 450(2). The packet flow control message includes the amount of buffer memory that is allocated for the wireless client 105 at the BSC 312. The wireless content switch 125 stores the amount of buffer memory that is allocated for the wireless client 105 at the BSC memory allocated indicator 465e (action 512) in the record associated with the wireless client 105.

Additionally, a QQS negotiation occurs between the SGSN 310, BSC 312, and the wireless client 105 (signals 513). The foregoing signals are received by the wireless content switch 125, at the client side port 450b(2). During the QOS negotiation, the throughput rate at which data is transmitted from the BSC 312 to the wireless client 105 is transmitted. The throughput rate is stored (action 514) at the throughput rate indicator 465h of the record associated with the wireless client 105 by the wireless content switch 125.

As packets (signal 515) are transmitted towards the wireless client 105, the packets are received at the SGSN 310 via server side port 450b(1). Wireless content switch 125 determines the identity of the wireless client 105 and increments the data received indicator 465c in the record 465 associated with the wireless client 105 (action 525).

When the SGSN 310 transmits data packets (signal 530) to the wireless client 105, the packets are received at wireless content switch 125 via the client side port 450b(2). The wireless content switch 125 determines the identity of the wireless client 105 and increments the SGSN data sent indicator 465d and BSC data received indicator 465f in the record 465 associated with the wireless client 105 by the amount of data in the packets (action 535).

When the wireless client 105 receives the data packets, signal 430, the wireless client 105 transmits an acknowledgment (signal 540) towards the content server 110. The acknowledgment indicates the last contiguous packet received, as well as the amount of available memory at the wireless client 105. The signal is received at wireless content switch 125 at the server side port 450b(1). The wireless content switch 125 determines the identity of the wireless client 105 and compares the amount of memory available at the wireless client 105 with the combined estimated amount of available allocated memory at the SGSN 310 and BSC 312 for the wireless client 105.

The amount of available allocated memory at the SGSN 310 for the wireless client 105 is determined by subtracting the used allocated memory from the value in the allocated memory indicator 465b in the record 465 associated with the wireless client 105. The amount of used allocated memory is determined by subtracting the value in the sent data indicator 465d from the value in the received data indicator 465c in the record 465 associated with the wireless client 105.

The amount of available allocated memory at the BSC 312 for wireless client 105 is determined by subtracting the used allocated memory from the value in the BSC allocated memory indicator 465e. The amount of used allocated memory is determined by subtracting the value in the BSC sent data indicator 465f from the value in the BSC sent indicator 465g in the record 465 associated with the wireless client 105.

The lesser of the amount of available allocated memory at the SGSN 310 and BSC 312 and the available memory at the wireless client 105 is inserted into the acknowledgment (action 545). The acknowledgment is then transmitted towards the content server 110 via an upstream port 450a (signal 540′).

Although the foregoing detailed description describes certain embodiments with a degree of specificity, it should be noted that the foregoing embodiments are by way of example, and are subject to modifications, substitutions, or alterations without departing from the spirit or scope of the invention. For example, one embodiment can be implemented as sets of instructions resident in memory 455. In another embodiment, the wireless content switch 125 may be disposed between the SGSN 310 and the BSC 312. Those skilled in the art will recognize that physical storage of instructions physically changes the medium upon which it is stored electronically, magnetically, or chemically so that the medium carries computer readable information. Accordingly, the inventions are only limited by the following claims, and equivalents, thereof.

What is claimed is:

1. A method for controlling data transmission from a server to a wireless client, said method comprising:
estimating an amount of available memory allocated for the wireless client at a plurality of nodes;
receiving a message from the wireless client which includes a field that indicates the amount of available memory at the wireless client; and
replacing the field with the amount of available memory allocated for the wireless client at the plurality of nodes.

2. The method of claim 1, wherein estimating the amount of available memory allocated for the wireless client at the plurality of nodes further comprises:
estimating an amount of memory at a first node allocated for the wireless client which is used; and
subtracting the estimated amount of memory allocated at the first node for the wireless client which is used from an amount of memory allocated at the node for the wireless client.

3. The method of claim 2, wherein subtracting further comprises:
receiving a message from the first node, wherein the message includes a downlink buffer size field; and
subtracting the estimated amount of memory allocated at the first node for the wireless client which is used from the downlink buffer size.

4. The method of claim 3, wherein receiving a message from the first node comprises:
receiving a link layer control message from the first node.

5. The method of claim 2, wherein estimating an amount of memory at the first node allocated for the wireless client which is used, further comprises:
measuring amount of data which is received from the first node for the wireless client;
receiving a signal which indicates amount of data which is received at the first node for the wireless client; and
subtracting the amount of data which is received from the first node from the amount of data which is received at the first node.

6. The method of claim 1, wherein estimating an estimated amount of memory at the plurality of nodes allocated for the wireless client which is used, further comprises:
estimating the amount of memory at a SGSN allocated for the wireless client which is used; and
estimating the amount of memory at a base station controller allocated for the wireless client which is used.

7. The method of claim 1, wherein receiving the message from the wireless client further comprises:
receiving an acknowledgment from the wireless client.

8. The method of claim 7, further comprising:
transmitting an acknowledgment to the content server, wherein the acknowledgment includes the amount of available memory for the wireless client at the plurality of nodes.

9. A system for controlling transmission between a server and a wireless client, said system comprising:
a processor for estimating an amount of available memory allocated for the wireless client at a plurality of nodes;
a first port for receiving a message from the wireless client, said message including a field indicating the available memory at the wireless client; and
a second port for transmitting the message to the content server, wherein the field indicating the available memory at the wireless client includes an indicator which indicates the estimated amount of available memory allocated for the wireless client at the plurality of nodes.

10. The system of claim 9, wherein the system comprises:
a third port for receiving data packets from a first node to the wireless client.

11. The system of claim 9, further comprising:
a first memory for counting the number of data packets transmitted to the first node for a particular client; and
a second memory for counting the data packets transmitted from the first node to the particular wireless client.

12. The system of claim 11, further comprising:
a third memory for measuring amount of data that is transmitted to the second node for the particular wireless client; and
a fourth memory for measuring amount of data that is received at the particular wireless client.

13. The system of claim 12, wherein the system receives a message from the first node to the wireless client, said message including a downlink buffer size field, and wherein the system further comprises:
a fifth memory for storing the downlink buffer size field.

14. The system of claim 9, wherein the plurality of nodes comprise an SGSN and a base station controller.

15. The system of claim 9, wherein the message further comprises:
an acknowledgment from the wireless client, acknowledging the receipt of data packets.

16. An apparatus for controlling transmission of data from a content server to a wireless client, said apparatus comprising a computer readable medium for storing a plurality of executable instructions, said plurality of instructions comprising:
estimating an amount of available memory allocated for the wireless client at a plurality of nodes;
replacing a field in a message from the wireless client which that indicates the amount of available memory at the wireless client with the amount of available memory allocated for the wireless client at the plurality of nodes; and
transmitting the message to the content server.

17. The apparatus of claim 16, wherein the instructions comprising estimating the amount of available memory allocated for the wireless client at the plurality of nodes further comprise:
estimating an amount of memory at each of the plurality of nodes allocated for the wireless client which is used; and
subtracting the estimated amount of memory allocated at each of the plurality of nodes for the wireless client which is used from an amount of memory allocated at each of the plurality of nodes for the wireless client.

18. The apparatus of claim 17, wherein the instructions for subtracting further comprise:
subtracting the estimated amount of memory allocated at a first node for the wireless client which is used from a downlink buffer size field contained in a link layer control message transmitted from the first node to the wireless client.

19. The apparatus of claim 17, wherein the instructions for estimating an amount of memory at the plurality of nodes allocated for the wireless client which is used, further comprises:
measuring amount of data that is received from the first node for the wireless client;
measuring amount of data which is received at the first node; and
subtracting the amount of data which is received from the first node from the data packets which are received at the first node.

20. The apparatus of claim 16, wherein the message from the wireless client further comprises an acknowledgment acknowledging receipt of data packets from the wireless client.
